(19) United States
(12) Patent Application Publication
(10) Pub. No.: US 2008/0137379 A1
(43) Pub. Date: Jun. 12, 2008

(54) Pulse width modulation for synchronous rectifiers in DC-DC converters

(76) Inventor: Hong Mao, San Jose, CA (US)

Correspondence Address: HARNESS, DICKEY, & PIERCE, P.L.C, 7700 Bonhomme, Suite 400, ST. LOUIS, MO, 63105, US

(21) Appl. No.: 11/637,604

(22) Filed: Dec. 12, 2006

(51) Int. Cl. H02M 3/335

(52) U.S. Cl. 363/17; 363/21.06

(57) ABSTRACT

A dc-dc converter includes a converter circuit having at least one synchronous rectifier and an active switch. A voltage compensator is connected to an output voltage of the converter circuit and produces a control voltage. A pulse width modulator output is connected to each of the synchronous rectifiers and the active switch. A pulse width modulator input is connected to the control voltage for driving the active switch and the synchronous rectifier with a modulated signal.

### FIELD

The present disclosure relates to pulse width modulation in dc-dc converters and more particularly to digital pulse width modulation of dc-dc converters with synchronous rectifiers.

### BACKGROUND

The statements in this section merely provide background information related to the present disclosure and may not constitute prior art. Synchronous rectifiers (SR) have been widely used in dc-dc converters to replace Schottky diodes to reduce conduction loss and improve conversion efficiency. In a dc-dc converter with synchronous rectifiers, the inductor(s) normally operate at continuous current mode (CCM) regardless of load and input voltage. At light load, inductor current becomes negative during the inductor freewheeling period because of the Field Effect Transistor's (FET) characteristic of bidirectional current conduction. The energy stored in the inductor is delivered back to an input of the converter when the SR switch(es) are turned off. In other words, there is circulating energy also called reactive power between the converter input and output, which significantly degrades conversion efficiency. FIG. 1(a) shows a prior art synchronous buck converter, where the active switch S and synchronous rectifier switch SR are driven by complementary signals. There are 3 cases of inductor current waveforms shown in FIG. 1(b) corresponding to different load conditions. Load current decreases from case 1 to case 3, and the inductor current freewheels to negative during the on time of SR.

Among the known techniques to improve light load efficiency, an approach is to turn the SR switch(es) off at light load to force the inductor current to flow through body diode(s) of the SR switch(es) during the freewheeling period. However, this efficiency improvement is limited to a very narrow range between very light load and open load. This is especially true for low-voltage high-current output applications, because the voltage drop across the body diode increases nonlinearly with current increase and quickly becomes higher than that across the SR.

Another common approach to improve efficiency at light load is emulating the unidirectional conduction characteristic of diodes by sensing the SR body diode conduction and turning the SR switch on and off. An SR driver integrated circuit (IC) is developed to implement current sense and SR driving. The IC controls one or more parallel N-FETs to emulate the behavior of Schottkty diode rectifiers. The drain-source voltage of a SR is sensed differentially to determine the polarity of the current and turn the SR switch on and off in proximity of the zero current transition. This technique requires a high noise-immunity differential amplifier to precisely control the turning on and off of a SR. Moreover, when the converter transitions from the discontinuous current mode (DCM) to continuous current mode (CCM) with increased load current, there is no potential negative current flowing through the FET and at this transition the above-mentioned method of current polarity sensing does not work. In this case, additional control methods and circuitry needs to be added—complicating the control circuitry and reducing reliability.

### SUMMARY

Further areas of applicability will become apparent from the description provided herein. It should be understood that the description and specific examples are intended for purposes of illustration only and are not intended to limit the scope of the present disclosure.

According to one example of the present disclosure a dc-dc converter with a dc-dc converter circuit has at least one synchronous rectifier, an active switch, and an input voltage and an output voltage. A voltage compensator is connected to the output voltage and produces a control voltage. A digital pulse width modulator has an output connected to each synchronous rectifier and the active switch, and a pulse with modulation input connected to the control voltage. The digital pulse width modulator drives the active switch and synchronous rectifier with a modulated signal.

Another example of the present disclosure is a digital pulse width modulator for controlling a synchronous dc-dc converter. The modulator has a first input for receiving a control voltage signal. A part of the modulator is a first modulated signal generator that controls an active switch of the converter and the first modulated signal is a function of the control voltage signal and has a first duty cycle. Another part of the modulator is at least one second modulated signal generator that controls a synchronous rectifier of the converter and the second modulated signal is a function of the control voltage signal and has a second duty cycle.

Still another example of the present disclosure is a dc-dc converter that has a dc-dc converter circuit with at least one synchronous rectifier, an active switch, and an input voltage and an output voltage. A voltage compensator is connected to the output voltage and produces a control voltage. A pulse width modulator has a first output connected to the active switch, a second output connected to the synchronous rectifier, and a pulse width modulator input connected to the control voltage. The digital pulse width modulator includes a first modulated signal generator for controlling the active switch of the converter and at least one second modulated signal generator for controlling the synchronous rectifier of the converter. The first modulated signal is a function of the control voltage signal and has a first duty cycle and the second modulated signal is a function of the control voltage signal and has a second duty cycle.

### DRAWINGS

The drawings described herein are for illustration purposes only and are not intended to limit the scope of the present disclosure in any way.

FIG. 1(a) is a prior art synchronous buck converter;

FIG. 1(b) is the timing and inductor current waveforms for FIG. 1(a);

FIG. 2(a) is an example of a converter in accordance with the present disclosure;

FIG. 2(b) is another example of a converter in accordance with the present disclosure;

FIG. 2(c) is a depiction of switch timing diagrams of FIG. 2(c);

FIG. 3 is an example of a synchronous buck converter in accordance with the present disclosure;

FIG. 4 is an example of a synchronous boost converter in accordance with the present disclosure;

FIG. 5(a) is an example of a synchronous forward converter in accordance with the present disclosure;

FIG. 5(b) is a depiction of key waveforms of FIG. 5(a) at light load;

FIG. 6(a) is an example of a synchronous flyback converter in accordance with the present disclosure;

FIG. 6(b) is a depiction of key waveforms of FIG. 6(a) at light load; and

FIGS. 7(a)-(c) show key waveforms of a synchronous buck converter in accordance with the present disclosure at varying load conditions.

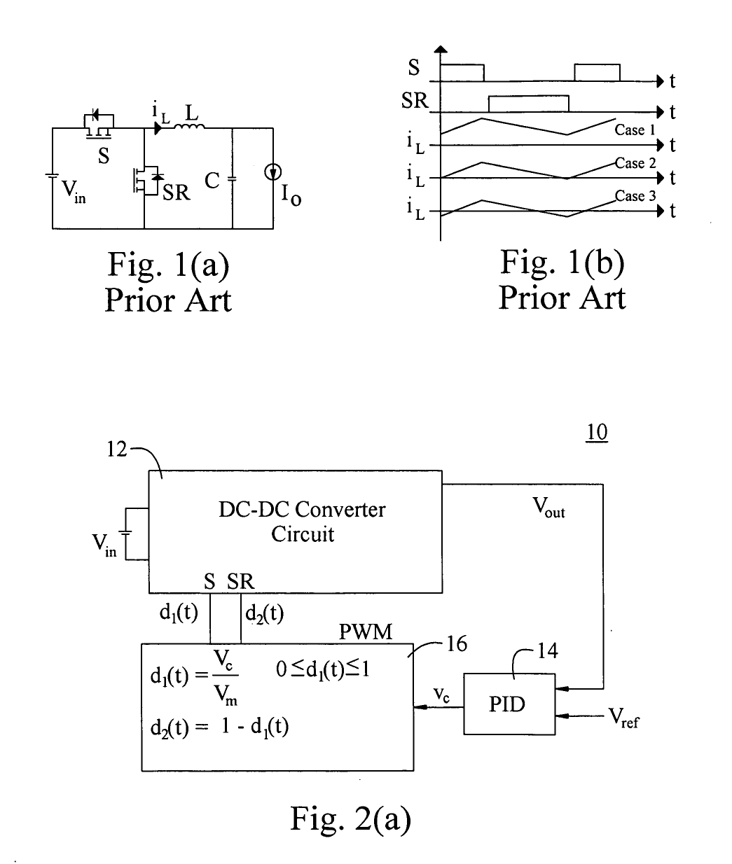

### DETAILED DESCRIPTION

The following description is merely exemplary in nature and is not intended to limit the present disclosure, application, or uses.

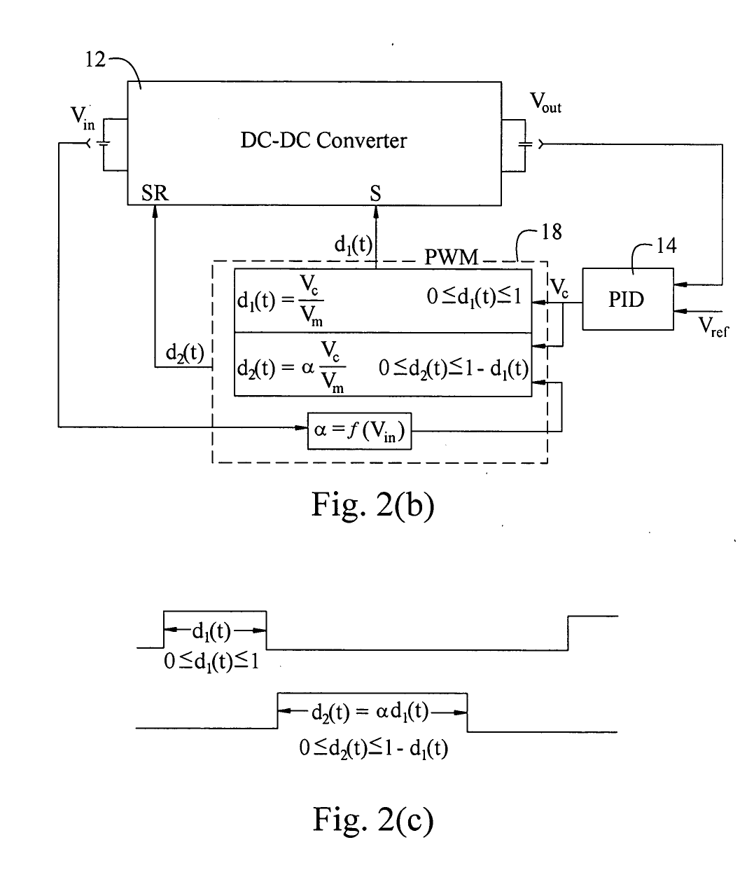

A synchronous dc-dc converter 10 controlled with an example of a PWM modulation scheme, in accordance with the present disclosure, is shown in FIG. 2. The dc-dc converter circuit 12 may include any isolated and non-isolated dc-dc converters with synchronous rectifiers, including buck, boost, flyback, forward, full bridge, half bridge, push pull dc-dc converters. For most dc-dc converters with synchrotrons rectifiers, there are an active switch S and at least one synchronous rectifier SR. In prior art dc-dc converters, the SR's drive signal is usually generated by inverting the signal of the active switch, S, allowing the converter to operate at CCM all the time, resulting in low efficiency at light load. In the discussion to follow the SR drive signal and the S drive signal are generated by pulse width modulation.

FIG. 2(a) shows a dc-dc converter 10 having a dc-dc converter circuit 12, a voltage compensator 14, and a digital pulse width modulator (PWM) 16. The circuit 12 includes at least one SR, a S, and an input voltage and an output voltage. The voltage compensator 14 is connected to the output voltage and produces a control voltage. The PWM 16 has an output connected to each SR and S and an input connected to the control voltage for driving S and each SR with a modulated signal.

As shown in FIG. 2(b), which is a variation of FIG. 2(a), a proportional-integral-derivative (PID) controller 14 generates a control voltage V_{c} based on an error signal between the output voltage Vₒᵤₜ and reference voltage V_{ref}. Other low pass filters suitable to the application may be used as a compensator instead of PID controller 14. The duty cycle d₁(t) for S and d₂(t) for SR are positively proportional to the control voltage. The switch SR is turned on after the switch S is turned off as shown in FIG. 2(c). The on-time of the switch SR is determined by the duty cycle d₂(t) generated from the pulse width modulation of pulse width modulator (PWM) 18.

In PWM block 18, Vᵢₙ is a modulation voltage that is a constant, and the other coefficient α is a function of the converter 12 input and output voltages. Since the output voltage is usually regulated and constant, the coefficient is only a function of the input voltage. For some applications, the input voltage is fixed and thus the coefficient α is fixed as well. If this is the case, the pulse width modulation of SR will be similar to that of S, except that the modulation ratios between control voltages to duty cycle values are different. As shown in FIG. 2(b), the duty cycle of switch S is:

$${d}_{1} ( t ) = \frac{1}{{V}_{m}} {V}_{c} \qquad ( 1 )$$

The duty cycle of the SR switch is:

$${d}_{2} ( t ) = α ( {V}_{in} ) \frac{1}{{V}_{m}} {V}_{c} = α ( {V}_{in} ) * {d}_{1} ( t ) \qquad ( 2 )$$

### It is clear that the duty cycle value for SR is a times the duty cycle of S. It is noted that the α in terms of input and output voltages varies from topology to topology.

Like in most dc-dc converters, the maximum duty cycle of the converters of this disclosure is limited. In single-ended converters such as buck, boost, flyback, and forward converters, the range of S is:

0≦d₁(t)≦1 (3)

In double-ended dc-dc converters such as full bridge, half bridge, and push pull converters, the duty cycle range of S is:

0≦d₁(t)≦0.5 (4)

For converters with synchronous rectifiers, the duty cycle range of an SR is:

0≦d₂(t)≦1−d₁(t) (5)

If the pulse width generated from modulation is higher than the limits, the pulse signals are truncated at the limits, which may be easily implemented by integrated circuitry. For example, periodically resetting a flip-flop automatically truncates a pulse signal.

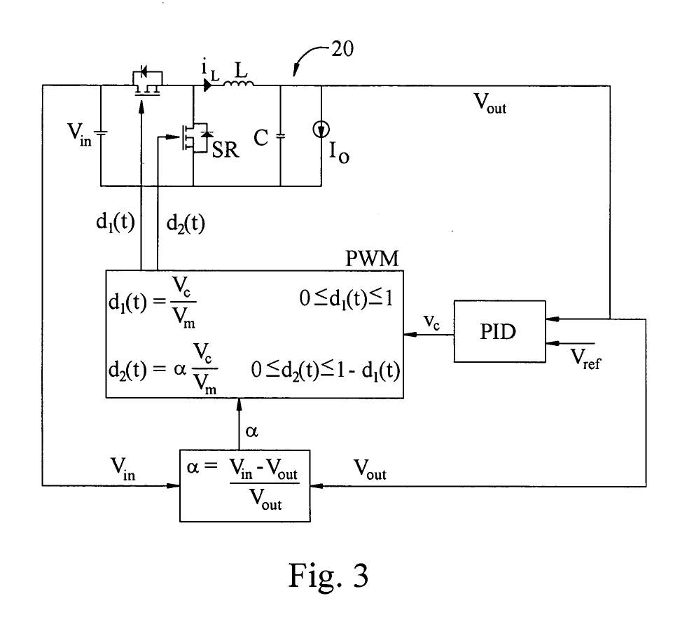

FIG. 3 shows an example in accordance with the present disclosure applied to a buck dc-dc converter circuit 20. Suppose converter 20 operates at steady state at a light-load condition, the steady-state duty cycle of the active switch is d₁, and the steady-state duty cycle of the SR is d₂. At light load, converter 20 operates at DCM for inductor L. In detail, when S turns on, the inductor current i_{L} is charged up from zero and when S is turned off SR is turned on, resulting in the inductor current decreasing towards zero. When i_{L} reaches zero, SR is turned off.

According to an example of a modulation scheme in accordance with the present disclosure, we obtain:

D₂=α*D₁. (6)

### When S is on, the inductor current is charged at a slope for a period of time d₁(t):

$$\frac{d {i}_{L}}{d t} = {V}_{in} - {V}_{out} \qquad ( 7 )$$

When S is turned off and SR is turned on, the inductor current freewheels according to the current slope for a period of time d₂(t) until the current reaches zero:

$$\frac{d {i}_{L}}{d t} = - {V}_{out} \qquad ( 8 )$$

According to the volt-seconds balance applied to an inductor, we have:

(Vᵢₙ−Vₒᵤₜ)D₁T=VₒᵤₜD₂T (9)

### Substituting Equation (6) into Equation (9) yields the modulation coefficient α:

$$α = \frac{{V}_{in} - {V}_{out}}{{V}_{out}} \qquad ( 10 )$$

It has been shown that SR modulation coefficient α is determined only by input and output voltages, and the inductance value has no effect on the a value.

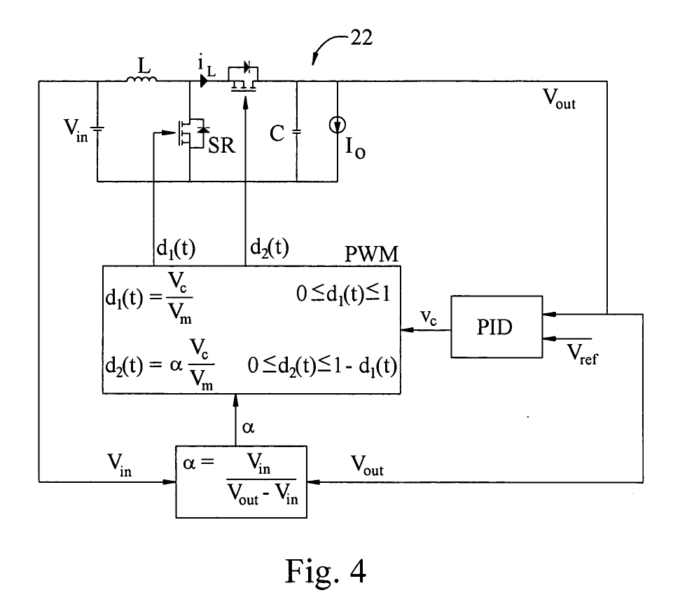

FIG. 4 shows an example in accordance with the present disclosure applied to a boost converter 22 with a SR. Appling the same method used above with the buck converter 20 to the boost converter 22, the modulation coefficient α for the SR can be derived:

$$α = \frac{{V}_{in}}{{V}_{out} - {V}_{in}} \qquad ( 11 )$$

The boost converter 22 with a SR is useful with battery-powered portable devices, where the dc-dc converter size is a concern. The disclosed modulation for SR improves light-load conversion efficiency. Moreover, for these types of applications in the prior art, it is desirable for the inductor to be as small as possible to save space at the expense of light-load efficiency. The present disclosure enables a designer to save converter power loss at light load compared to the prior art, which is advantageous for battery-powered devices.

Another application of the present disclosure is power factor correction. With a power factor corrector, in order to eliminate the multiplier and simplify control circuitry, a boost converter often operates at discontinuous inductor current mode or critical inductor current mode over the entire load range. In this case, the conduction loss dissipated in a boost diode is significant. A FET may replace the diode as a SR. However, the SR should be turned off before the inductor current goes negative. The disclosed pulse width modulation scheme can prevent the inductor current from going negative without needing to sense the inductor current as required in the prior art.

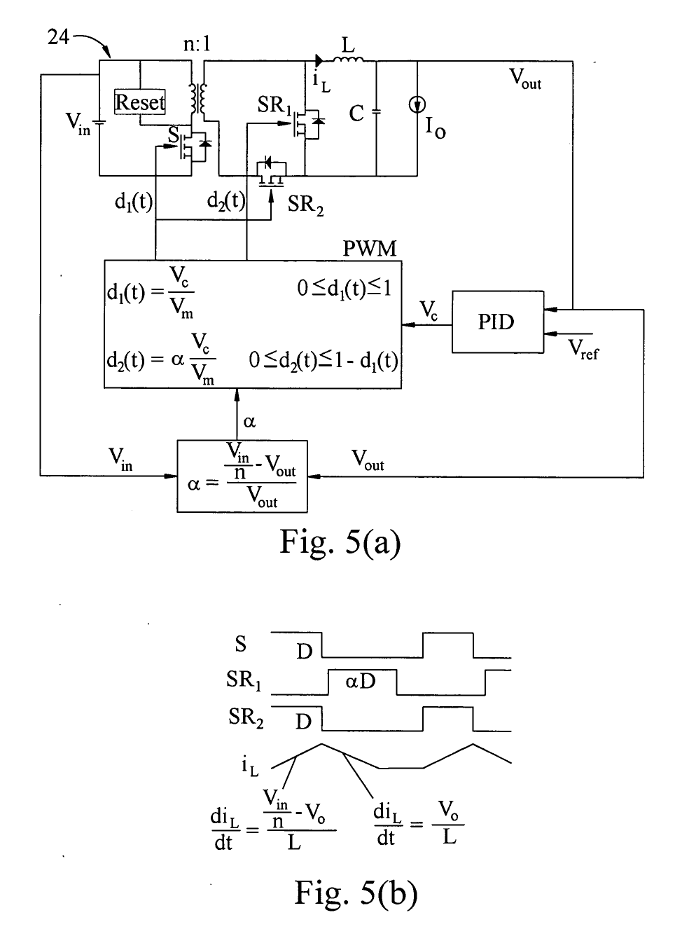

FIG. 5 shows the disclosed concept applied to forward converter 24 with a multiple SRs on the secondary side. The key waveforms at a light load condition are shown in FIG. 5(b). FET SR, is driven by the SR modulation signal d₂(t), and the SR₂ is driven by the S drive signal d₁(t). The converter 24 may be considered an isolated buck converter where the transformer converters the primary voltage to a secondary-side buck converter. The voltage applied to the buck converter is:

$${V}_{sec} = \frac{{V}_{in}}{n} \qquad ( 12 )$$

Considering V_{sec} as the input voltage Vᵢₙ in Equation (10), substituting Equation (12) into Equation (10) yields the modulation coefficient α for the SR, in the forward converter:

$$α = \frac{\frac{{V}_{in}}{n} - {V}_{out}}{{V}_{out}} \qquad ( 13 )$$

In addition to the efficiency improvement for light load conditions, the disclosed invention reduces the voltage spikes across SRI resulting from turning off SR₁ in prior art forward converters, including self-driven and external-driven techniques. In prior art forward converters, at a light load condition, the inductor current goes negative when SRI is on. Before the primary switch S is turned on, SR₁ is tuned off. However, the inductor current path is cut off by turning off the SR₁ since SR₂ is not on at that moment. As a result, a high voltage spike may be observed across the SR₁. This voltage spike in prior are converters requires a higher voltage rating for the synchronous FETs compared to the FETs required using the present disclosure. Thus, the present disclosure decreases cost and increases converter efficiency compared to the prior art. Based on tests conducted by the inventor, the voltage spike across the SR₁ at the condition of light load is even higher than at full load condition.

In a typical prior art flyback converter with SRs replacing diode rectifiers, the drive signal of a primary switch is complementary to the drive signal of SR. As discussed above, negative inductor current exists in other synchronous dc-dc converters. Likewise, in the flyback converter, the transformer magnetizing current goes negative at light load resulting in circulating current and additional conduction loss. This drawback is more serious when the flyback converter is designed to operate at DCM for a wide range of load, as is the case for a number of AC adaptor applications. In these wide load range applications, the stand-by power consumption requirement is strict. Therefore, the drive and timing of the SR are important in determining light-load efficiency. The present disclosure offers a simple, easily implemented and cost-effective solution to generate the drive signal for the SR switch.

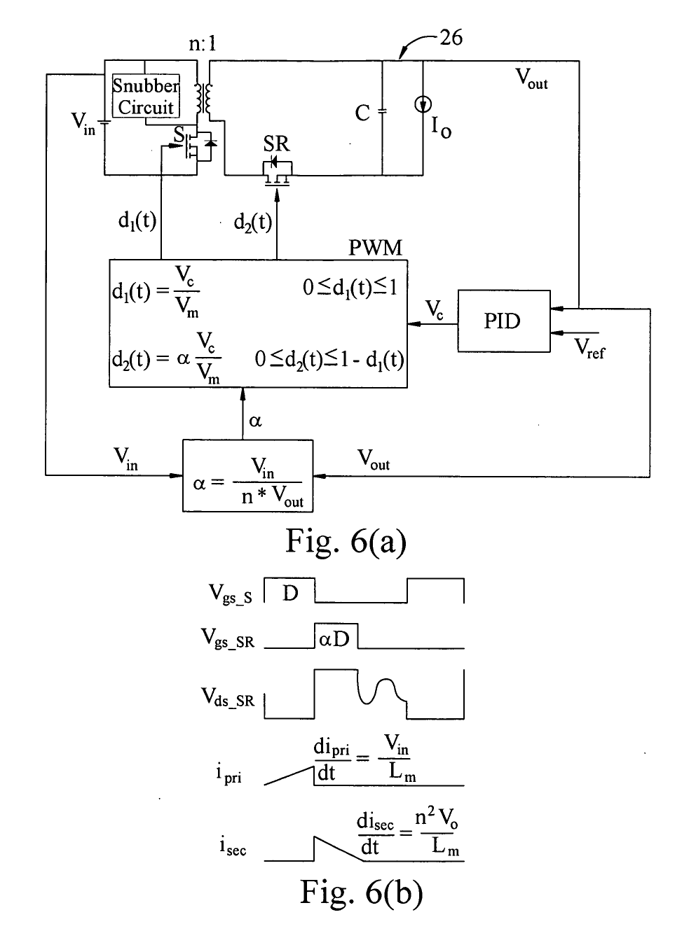

FIG. 6 is an example in accordance with the present disclosure applied to a flyback converter 26 with an SR on the secondary side. Key waveforms at a light load condition are shown in FIG. 6(b). SR is turned on after S is turned off. The on time of SR is determined by SR's pulse width modulation. The secondary FET switch SR is driven by the modulation-generated signal d₂(t), and S is driven by the signal d₁(t). The modulation coefficient α for the SR in the flyback converter is:

$${V}_{sec} = \frac{{V}_{in}}{{nV}_{out}} \qquad ( 14 )$$

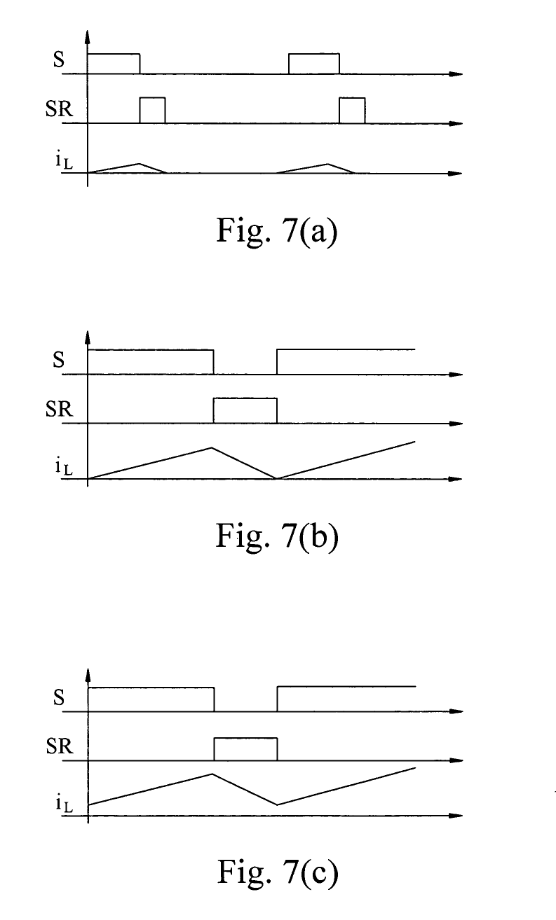

As discussed above, the present disclosure improves the dc-dc conversion efficiency at light load since the SR modulation prevents inductor current from going negative. One advantage of the present disclosure over the prior art is that the dc-dc converter may slide into CCM automatically when the load increases beyond a critical load current. For some converters at certain input and output voltages the critical load current is fixed. Using a buck converter, in accordance with the present disclosure, as an example, FIGS. 7(a)-(c) show key waveforms. The figures correspond to three modes of operation at different load conditions. FIG. 7(a) shows the light-load condition, where the inductor operates at DCM. As the load current increases, the duty cycles for both the active switch S and the synchronous switch SR increase as D₂=αD₁. As a result, the inductor peak current continues to increase due to longer inductor charge time, in order to regulate the output voltage. For DCM operation, the inductor freewheels through SR, and the inductor current decreases to zero before S is turned on. At a certain load current, the inductor current decreases to zero at the point where S is turned on. The corresponding load current is the so-called critical load current, and the corresponding waveforms are shown in FIG. 7(b). When the load increases beyond this critical load current level and to meet the load requirement, the inductor current waveform is shifted up and becomes continuous. This operation is commonly referred to as continuous inductor current mode or CCM. The corresponding waveforms of CCM operation are shown in FIG. 7(c).

Before the load current reaches the critical load current, the steady-state duty cycle values D₁ and D₂ for S and SR increase quickly with the increase of load current. When the load reaches the critical load current and goes beyond, the duty cycle values go into CCM. In CCM, the duty cycle value D₁ slightly increases as the load increases, and D₂ slightly decreases since the duty cycle value D₂ is cut back due to saturation. In other words, in CCM, the duty cycle value D₂=1−D, instead of D₂=αD₁ in DCM.

In the disclosed inventive pulse width modulator, the modulation coefficient a is an important factor determining the on time of the SR at light load. Advantageously, the modulation coefficient α does not have to be very accurate since the SR's turn-off timing is not critical. For example, due to the at tolerance, SR may be turned off before or after the inductor current reaches zero. If the SR is turned off before the inductor current reaches zero, the SR body diode continues to carry current. If the SR is turned off after the inductor current reaches zero, the inductor current may go slightly negative and the turn-off of SR is not going to impact the conversion efficiency. For both cases, given the fact that the current is close to zero, the turn-off timing is not critical, therefore high tolerance is obtained for the SR modulation.

The digital pulse width modulator, such as shown in FIGS. 2(b), 3, 4, 5(a), and 6(a), can be described as follows. The modulators all have a first input for receiving a control voltage signal. A first modulated signal generator generates a first modulated signal, the drive signal d₁(t), and controls as active switch, S, of the converter. The first modulated signal is a function of the control voltage signal and has a first duty cycle. At least one second modulated signal generator generates a second modulated signal, the drive signal d₂(t), and controls at least one synchronous rectifier, SR. The second modulated signal is a function of the control voltage signal and has a second duty cycle. The modulator may also have a coefficient generator (see FIG. 2(b)) for generating a coefficient that is a function of an input voltage of the converter and is inputted into the second modulated signal generator. In the example of FIG. 5 d,(t) is also applied to a second SR on the secondary side.

Unlike prior art techniques, the compensation of the time delay of the driver signal in accordance with the present disclosure is easy. In prior art techniques based on current or voltage polarity sensing, the time delay makes difference in conversion efficiency. This is especially true when a converter operates at CCM. The present disclosure is applicable over an entire load range even during the input voltage or load transients. Therefore, converters in accordance wit the present disclosure may be used in applications with high switching frequencies.

The converters disclosed above may be effectively implemented using digital controllers, but may also be implemented with analog controllers, especially integrated analog circuits. Known analog PWM techniques may be utilized to implement the SR modulation disclosed in accordance with the present disclosure. Digital control is able to provide various implementation methods. For example, software-based or hardware-based PWM may be utilized in accordance with the present disclosure. The present disclosure may be implemented using single dc-dc converters as shown and described above, it could also be used with multiple channels or multiple dc-dc converters in parallel.

A buck dc-dc converter controlled by a Silabs' digital controller Si8250 was selected as a test prototype. The prototype was originally designed with a prior art converter, where the drive signal for SR is complementary to the drive signal for S. By changing the digital PWM setup in the digital controller, an example in accordance with the present disclosure was implemented and verified. The efficiency and waveforms were measured and compared with the prior art converter.

The specification of the prototype was: Vᵢₙ=12V, Vₒᵤₜ=3.3V, Iₒᵤₜ=12 A. Component selection: S and SR were HAT2165, L=620 nH, C=480 uF

At light load it was observed that the converter operated at DCM. When the load current was increased up to 6 A, the converter transitioned into CCM.

To test the transient response, the converter was loaded with a pulse load from 0.5 A-8 A. It was observed that the converter operation mode automatically changed from DCM to CCM when the load current changed from 0.5 A to 8 A. The transient response is determined by the closed loop compensation.

At light load, the improvement in efficiency of the example in accordance with the present disclosure compared to the prior art buck converter was up to 10% at 0.5 A load. The example in accordance with the present disclosure also saved power loss compared to the prior art.

Thus it has been shown, that converters in accordance with the present disclosure improve conversion efficiency of dc-dc converters with SRs at DCM operation at light load due to reduced conduction loss, reduced inductor or transformer core loss, and reduced switching loss. Converters in accordance with the present disclosure may be advantageously applied in portable or handheld devices, wherein lower filter inductance is desired for lower converter volume, and a converter operates at DCM over a wide load range. Converters in accordance with the present disclosure are easily implemented into a digital controller without increasing the hardware cost. Some typical examples where the present disclosure may be applied include non-isolated or isolated dc-dc converters, paralleled converters, AC adaptors, handheld or portable devices, and laptop dc-dc converters.

The description of the present disclosure is merely exemplary and those skilled in the art will appreciate that variations other than those described will fall within the scope of the present disclosure.

What is claimed:

1. A dc-dc converter comprising:
a dc-dc converter circuit including at least one synchronous rectifier, an active switch, and having an input voltage and an output voltage;
a voltage compensator connected to the output voltage and producing a control voltage; and
a digital pulse width modulator having an output connected to each of the synchronous rectifiers and the active switch, and a pulse with modulation input connected to the control voltage, wherein the digital pulse width modulator output drives the active switch and synchronous rectifier with a modulated signal.

2. The converter of claim 1, wherein the converter is an isolated converter.

3. The converter of claim 1, wherein the converter is a non-isolated converter.

4. The converter of claim 2, wherein the converter is one of a plurality of paralleled converters.

5. The converter of claim 3, wherein the converter is one of a plurality of paralleled converters.

6. The converter of claim 1, wherein the dc-dc converter circuit is one of a buck, boost, flyback, forward, full-bridge, half-bridge, and a push-pull circuit.

7. The converter of claim 1, wherein the voltage compensator is a proportional-integral-derivative controller.

8. The converter of claim 1, wherein the digital pulse with modulator includes a coefficient that is a function of the input voltage.

9. The converter of claim 1, wherein the digital pulse width modulator includes a coefficient that is a fixed value.

10. The converter of claim 1, wherein the digital pulse width modulator includes a first modulated signal for controlling the active switch and a second modulated signal for controlling the synchronous rectifier.

11. The converter of claim 1, wherein the synchronous rectifier is turned on after the active switch is turned off.

12. A digital pulse width modulator for controlling a synchronous dc-dc converter, the modulator comprising:
a first input for receiving a control voltage signal;
a first modulated signal generator for producing a first modulated signal for controlling an active switch of the converter, wherein the first modulated signal is a function of the control voltage signal and has a first duty cycle; and
at least one second modulated signal generator for producing at least one second modulated signal for controlling a synchronous rectifier of the converter, wherein the second modulated signal is a function of the control voltage signal and has a second duty cycle.

13. The modulator of claim 12, further including a coefficient generator for generating a coefficient that is a function of an input voltage of the converter and is inputted into the second modulated signal generator.

14. The modulator of claim 12, wherein the converter to be controlled is one of a buck, boost, flyback, forward, full-bridge, half-bridge, and a push-pull circuit.

15. The modulator of claim 12, wherein the first input is connected to a voltage compensator.

16. The modulator of claim 12, wherein the first input is connected to a proportional-integral-derivative controller.

17. The modulator of claim 13, wherein the coefficient is a fixed value.

18. A dc-dc converter comprising:
a dc-dc converter circuit including at least one synchronous rectifier, an active switch, and having an input voltage and an output voltage;
a voltage compensator connected to the output voltage and producing a control voltage;
a pulse width modulator having a first output connected to the active switch and a second output connected to the synchronous rectifier and a pulse width modulator input connected to the control voltage; and
wherein the digital pulse width modulator includes:
a first modulated signal generator for producing a first modulated signal for controlling the active switch of the converter, wherein the first modulated signal is a function of the control voltage signal and has a first duty cycle; and
at least one second modulated signal generator for producing a second modulated signal for controlling the synchronous rectifier of the converter, wherein the second modulated signal is a function of the control voltage signal and has a second duty cycle.

19. The converter of claim 18, wherein the dc-dc converter circuit is one of a buck, boost, flyback, forward, full-bridge, half-bridge, and a push-pull circuit.

20. The converter of claim 18, wherein the voltage compensator is a proportional-integral-derivative controller.

21. The converter of claim 18, further including a coefficient generator for generating a coefficient that is a function of an input voltage of the converter and is inputted into the second modulated signal generator.

22. The converter of claim 21, wherein the coefficient is a fixed value.

23. The converter of claim 18, wherein the pulse width modulator is digital.

24. The converter of claim 18, wherein the pulse width modulator is analog.
